(19) United States
(12) Patent Application Publication
(10) Pub. No.: US 2025/0310802 A1
(43) Pub. Date: Oct. 2, 2025

(54) COMMUNICATION METHOD AND COMMUNICATION APPARATUS

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN)

(21) Appl. No.: 19/239,060

(22) Filed: Jun. 16, 2025

Related U.S. Application Data
(63) Continuation of application No. PCT/CN2022/140588, filed on Dec. 21, 2022.

(51) Int. Cl. H04W 24/08; H04W 74/0808; H04W 92/18

(52) U.S. Cl. CPC H04W 24/08; H04W 74/0808; H04W 92/18

(57) ABSTRACT

Provided are a communication method and a communication apparatus. The method comprises: a first device sending a physical sidelink shared channel (PSSCH) to a second device; and the first device performing radio link failure (RLF) detection according to the reception situation of a physical sidelink feedback channel (PSFCH) corresponding to the PSSCH.

### CROSS-REFERENCE TO RELATED APPLICATIONS

This application is a continuation of International Application No. PCT/CN2022/140588, filed on Dec. 21, 2022, the disclosure of which is hereby incorporated by reference in its entirety.

### TECHNICAL FIELD

This application relates to the field of communications technologies, and more specifically, to a communication method and a communications apparatus.

### BACKGROUND

In some communications systems, a transmitting-end terminal device (Tx UE) may determine, based on a number of consecutive discontinuities reception (DTX) on feedback information, whether a radio link failure (RLF) occurs on a link. However, a current determining method may not be appropriate.

### SUMMARY

Embodiments of this application provide a communication method and a communications apparatus. The following describes various aspects involved in embodiments of this application.

According to a first aspect, there is provided a communication method. The communication method includes: transmitting, by a first device, a physical sidelink shared channel PSSCH to a second device; and performing, by the first device, radio link failure RLF detection based on a reception status of a physical sidelink feedback channel PSFCH corresponding to the PSSCH.

According to a second aspect, there is provided a communications apparatus. The communications apparatus is a first device, the first device includes a memory and a processor, the memory is configured to store a computer program, and the processor is configured to execute the computer program stored in the memory to cause the communication apparatus to perform operations including: transmitting a physical sidelink shared channel PSSCH to a second device; and performing radio link failure RLF detection based on a reception status of a physical sidelink feedback channel PSFCH corresponding to the PSSCH.

According to a third aspect, there is provided a communications apparatus. The communications apparatus is a second device, the second device includes a memory and a processor, the memory is configured to store a computer program, and the processor is configured to execute the computer program stored in the memory to cause the communication apparatus to perform operations including: receiving a physical sidelink shared channel PSSCH transmitted by a first device; and determining whether to transmit a physical sidelink feedback channel PSFCH corresponding to the PSSCH.

### BRIEF DESCRIPTION OF DRAWINGS

FIG. 1 is an example diagram of a wireless communications system to which an embodiment of this application is applied.

FIG. 2 is an example diagram of a wireless communications system to which another embodiment of this application is applied.

FIG. 3 is an example diagram of a wireless communications system to which still another embodiment of this application is applied.

FIG. 4 is a schematic flowchart of a communication method according to an embodiment of this application.

FIG. 5 is a schematic flowchart of a communication method according to another embodiment of this application.

FIG. 6 is a schematic flowchart of a communication method according to still another embodiment of this application.

FIG. 7 is a schematic structural diagram of a communications apparatus according to an embodiment of this application.

FIG. 8 is a schematic structural diagram of a communications apparatus according to another embodiment of this application.

FIG. 9 is a schematic structural diagram of an apparatus according to an embodiment of this application.

### DESCRIPTION OF EMBODIMENTS

Technical solutions in this application are described below with reference to the accompanying drawings.

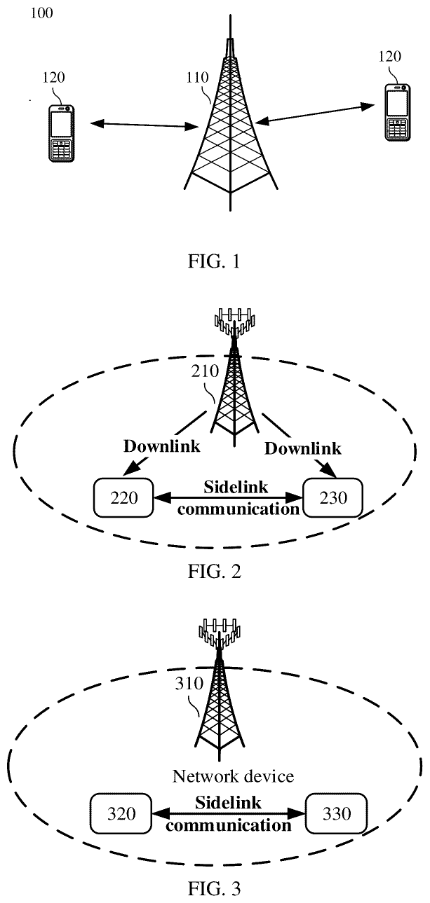

FIG. 1 shows a wireless communications system 100 to which embodiments of this application are applied. The wireless communications system 100 may include a network device 110 and a user equipment (UE) 120. The network device 110 may communicate with the UE 120. The network device 110 may provide communication coverage for a specific geographic area, and may communicate with the UE 120 within the coverage. The UE 120 may access a network (for example, a wireless network) by using the network device 110.

FIG. 1 exemplarily shows one network device and two UEs. In at least one embodiment, the wireless communications system 100 may include a plurality of network devices, and another quantity of terminal devices may be included in coverage of each network device, which is not limited in embodiments of this application. In at least one embodiment, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and an LTE time division duplex (TDD) system. The technical solutions provided in this application may be further applied to a future communications system, such as a 6th generation mobile communications system or a satellite communications system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. In at least one embodiment, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device for communicating with the UE. The network device may also be referred to as an access network device or a radio access network device. For example, the network device may be a base station. The network device in embodiments of this application may be a radio access network (RAN) node (or device) that connects the UE to a wireless network. The base station may broadly cover devices having the following various names, or may be interchanged with the devices having following names, such as a NodeB, an evolved NodeB (eNB), a next generation NodeB (gNB), a relay station, an access point, a transmitting and receiving point (TRP), a transmitting point (TP), a master eNode MeNB, a secondary eNode SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head RRH), a central unit (CU), a distributed unit (DU), and a positioning node. The base station may be a macro base station, a micro base station, a relay node, a donor node, or the like, or a combination thereof.

In some embodiments, the network device may be stationary or mobile. For example, a helicopter or an unmanned aerial vehicle may be configured to function as a mobile network device, and one or more cells may move depending on a location of the mobile network device. In other examples, a helicopter or an unmanned aerial vehicle may be configured to function as a device that communicates with another network device. In some embodiments, the network device may be a CU or a DU, or the network device may include a CU and a DU, or the network device may further include an AAU.

It should be understood that the network device may be deployed on land, including being indoors or outdoors, handheld, or vehicle-mounted, may be deployed on a water surface, or may be deployed on a plane, a balloon, or a satellite in the air. In embodiments of this application, the network device and a scenario in which the network device is located in embodiments of this application are not limited.

It should also be understood that all or some of functions of the network device and the UE in this application may also be implemented by software functions running on hardware, or by virtualization functions instantiated on a platform (for example, a cloud platform).

With the development of communications technologies, a sidelink (SL) transmission technology is introduced in some communications systems, to improve transmission efficiency. Sidelink communication may be classified, depending on different network coverage statuses of a terminal device that performs communication, into sidelink communication within network coverage and sidelink communication out of network coverage, specifically as shown in FIG. 2 and FIG. 3, respectively.

In the sidelink communication within network coverage, all terminal devices that perform sidelink communication are within coverage of a same base station. As shown in FIG. 2, both terminal devices 220 and 230 are within network coverage of a network device 210, and can receive a sidelink configuration transmitted by the network device 210 via a downlink, and perform sidelink communication based on the sidelink configuration.

For the sidelink communication out of network coverage, all terminal devices that perform sidelink communication are out of network coverage. As shown in FIG. 3, both terminal devices 320 and 330 are out of network coverage of a network device 310. In this case, the terminal devices 320 and 330 may each determine a sidelink configuration based on pre-configuration information, and may perform sidelink communication based on the sidelink configurations.

Device-to-device (D2D) communication is a sidelink transmission technology. Different from a conventional cellular system in which communication data is transmitted by using a base station, in D2D communication, a terminal-to-terminal direct communication mode is used, which therefore has higher spectral efficiency and lower transmission latency. D2D communication may be applied to a vehicle-to-everything system.

In the 3rd generation partnership project (3GPP), two resource acquisition modes: a mode A and a mode B, are defined for D2D. Details are as follows:

Mode A: A transmission resource for a terminal device is allocated by a base station, and the terminal device may transmit data on a sidelink by using the resource allocated by the base station. The base station may allocate a transmission resource for a single time of transmission to the terminal device, or may allocate a resource for semi-persistent transmission to the terminal device. For example, as shown in FIG. 2, both terminal devices 220 and 230 are within network coverage of the network device 210, and can receive a transmission resource allocated by the network device 210, and perform sidelink communication by using the transmission resource.

Mode B: A terminal device may select a resource from a resource pool to perform sidelink transmission. For example, as shown in FIG. 2, both the terminal devices 320 and 330 may select a resource from a resource pool, and perform sidelink communication by using the transmission resource. It should be noted that FIG. 3 shows a case in which both the terminal devices 320 and 330 are within network coverage of the network device 310. Certainly, at least one of the terminal devices 320 and 330 may be out of network coverage of the network device 310, which is not limited in this application.

In 3GPP, D2D is researched according to the following different stages.

(1) Proximity-based service (ProSe): in some versions (such as R12 and R13) of communication protocols, research has been conducted on ProSe scenarios, which are mainly aimed at public safety services. In ProSe, a location of a resource pool in time domain may be configured (for example, resources in the resource pool are discontinuous in time domain), such that a terminal device discontinuously transmits or receives data on a sidelink, thereby achieving a power saving effect.

(2) Vehicle to everything (V2X): In some versions (for example, R14 and R15) of communication protocols, research has been conducted on vehicle-to-everything scenarios for vehicle-to-vehicle communication, which is mainly for services of communication between vehicles or between a vehicle and a person that move at a relatively high speed. In V2X, since a vehicle-mounted system has continuous power supply, latency of data transmission is a major problem, rather than power and efficiency. Therefore, a terminal device is required to perform continuous transmission and reception in a system design.

(3) Wearable device (further enhancement device-to-device, FeD2D): In some versions (for example, R14) of communication protocols, research has been conducted on a scenario of a wearable device accessing a network through a smartphone, which is mainly aimed at scenarios with a low moving speed and low power access. In FeD2D, in a pre-research stage, it is concluded that a base station may configure a DRX parameter of a remote terminal device by using a relay terminal device. However, this topic is not further standardized. Therefore, details of how to configure DRX are not conclusive.

In NR, based on LTE V2X, V2X is no longer limited to a broadcast scenario, but is further extended to unicast and multicast scenarios. In these scenarios, application of V2X is studied.

Similar to LTE V2X, two resource acquisition modes: a mode 1 and mode 2, are also defined for NR V2X. The mode 1 is similar to the mode A, and the mode 2 is similar to the mode B. Further, in NR, a terminal device may be in a mixed mode, that is, the terminal device may acquire a resource by using the mode 1, and may also acquire a resource by using the mode 2.

Different from LTE V2X, in addition to hybrid automatic repeat request (HARQ) retransmission independently initiated by a terminal device without feedback, feedback-based HARQ retransmission is introduced into NR V2X, which applies not only to unicast communication but also to multicast communication.

Further, similar to LTE V2X, in NR V2X, because a vehicle-mounted system has continuous power supply, latency of data transmission is a major problem, rather than power and efficiency. Therefore, a terminal device is required to perform continuous transmission and reception in a system design.

The technical solutions in embodiments of this application may be applied to an unlicensed band (unlicensed spectrum). An LTE system and an NR system may perform communication on unlicensed spectrum by using a long term evolution in unlicensed spectrum (LTE-U) technology and a new radio in unlicensed spectrum (NR-U) technology, respectively.

Before performing communication in an unlicensed band, a terminal device is required to perform channel access, to determine whether a channel is idle. A channel access process may also be referred to as a “listen before talk” (LBT) process. If a channel is idle, the terminal device may access the channel and transmit data. Otherwise, the terminal device cannot access the channel until the channel is idle.

In NR-U, when the UE detects a same uplink LBT failure, the UE takes actions specified in a protocol (such as the protocol TS 38.321[6]). The detection is on a basis of each bandwidth part (bandwidth part BWP) and all uplink transmissions within the BWP. When a same uplink LBT failure is detected in a secondary cell (SCell), the UE reports the failure to a corresponding gNB (a master node (master node, MN) for a master cell group (MCG), or a secondary node (SN) for a secondary cell group (SCG)) by using a MAC CE on a serving cell different from the SCell where the failure is detected. If no resource is available for transmitting a medium access control control element (MAC CE), the UE may transmit a scheduling request (SR). When a same uplink LBT failure is detected in a special cell (SpCell), the UE switches to another uplink (UL) BWP configured with a random access channel (random access channel, RACH) resource in the cell, initiate an RACH, and report the failure by using a MAC CE. When a plurality of UL BWPs may be used for switching, the UE may select one of the UL BWPs. For a primary secondary cell (PSCell), if a same uplink LBT failure is detected within all UL BWPs configured with RACH resources, the UE may declare an SCG RLF and report the failure to an MN by using SCGFailureInformation. For a primary cell (PCell), if an uplink LBT failure is detected within all UL BWPs configured with RACH resources, the UE may declare an RLF.

In a sidelink in unlicensed spectrum (SL-U), channel occupancy time (COT) may be shared between UEs if a regulatory requirement is met, that is, a terminal that initiates COT may share obtained COT with another COT sharing terminal for direct communication. For example, COT may be shared at least between UEs for which a PC5 radio resource control (radio resource control, RRC) connection is established.

To ensure that an SL-U device can continuously use a channel within obtained COT, a guard period (guard period, GP) of 16 us may be arranged in an SL-U frame structure. Reuse of CP extension (extension) may be considered, to reduce a GP length. In addition, whether to use a logical slot or a physical slot in a COT sharing mechanism in SL-U may be discussed later.

In COT sharing of the SL-U system, the terminal may complete COT sharing through indication of COT sharing information. It is required to determine whether to carry the COT information in physical layer control signalling (sidelink control information, SCI). If the sharing information is carried in the SCI, it is required to consider processing time in the design of COT sharing in SL-U, that is, it is required to consider time required for the UE to receive and decode the COT sharing information carried in the SCI, and also consider a relationship between the processing time and minimum listen time specified in regulations.

In an SL-U system, COT sharing information indicated by a terminal that initiates COT at least includes: remaining COT duration information, available sub-band information (the information may be acquired based on resource indication information carried in the SCI), channel access priority class (CAPC) information, or COT sharing ID information.

In an SL-U system, the COT sharing information inherited by a terminal with which the COT is shared at least includes: remaining COT duration information, available sub-band information (the information may be acquired based on resource indication information carried in the SCI), CAPC information, or COT sharing identity (ID) information.

For inheritance and forwarding of the COT sharing information, the following condition of the processing time is required to be met: a time length between an end location of a symbol for receiving the SCI and a starting location of a symbol for transmitting the SCI is greater than or equal to Tproc, SL-U, where Tproc, SL-U is the processing time that is required to be considered for inheritance and forwarding of the COT sharing information.

When a plurality of pieces of COT sharing information that meet the condition of the processing time are received by the terminal, suitable COT sharing information may be selected, by using the following solution, for inheritance and forwarding.

The terminal selects, based on remaining COT lengths in the plurality of pieces of COT sharing information, COT sharing information with the longest remaining COT length for inheritance and forwarding. The COT sharing information with the longest remaining COT length forwarded by the terminal is determined with respect to a transmission instant of the terminal.

When remaining COT lengths determined based on the plurality of pieces of COT sharing information are identical, the terminal selects, based on CAPC values in the plurality of pieces of COT sharing information, COT sharing information with a maximum CAPC value for inheritance and forwarding.

It should be noted that the plurality of pieces of COT sharing information are a plurality of pieces of COT sharing information that can be used by the terminal. Furthermore, in addition to the foregoing solutions, further research may be conducted on how to inherit and forward COT information based on resource block (RB) set (set) information in the COT sharing information.

The COT sharing ID information may include at least one or more of the following: a target terminal ID, a terminal group ID, service identity information, or an SL zone ID.

In COT sharing of an SL-U system, when the COT sharing condition is met, the terminal is allowed to perform COT sharing.

For a COT sharing condition, it may be considered that COT is shared between UEs within a terminal group determined based on the COT sharing ID information.

In the COT sharing mechanism, whether COT shared by another terminal is valid may also be based on an implicit public group, and determined based on an evaluation result of a responding device terminal. The following criteria may be considered in evaluation standards of COT sharing of the responding device terminal:
an expected COT sharing range/area, where the sharing range/area may be determined based on an SL Zone ID, reference signal received power (RSRP) measurement, or in another manner; or
channel quality measurement of the responding device terminal, such as RSRP threshold, or channel busy ratio (CBR) related measurement, or the like.

On a sidelink, RLF detection based on hybrid automatic repeat request (HARQ) feedback may be performed. For example, a reception occasion of a physical sidelink feedback channel (PSFCH) in a PC5-RRC connection may be detected; and if a specific number of consecutive DTX (discontinuities reception) on PSFCH reception occasions is detected, it is considered that an RLF has occurred on the sidelink.

The RRC may configure the following parameters to control sidelink RLF detection based on HARQ feedback:
1. sl-maxNumConsecutiveDTX: represents a maximum number of consecutive DTX on PSFCH reception occasions;
2. numConsecutiveDTX: a count used for HARQ-based sidelink RLF detection (may be maintained per PC5-RRC connection).

For each PC5 connection, if the connection is newly established or sl-maxNumConsecutiveDTX is re-configured, a sidelink HARQ entity may (re) initialize numConsecutiveDTX corresponding to each PC5-RRC connection to zero.

The sidelink HARQ entity may perform the following operations for each PSFCH reception occasion associated with the transmission of the physical sidelink shared channel (PSSCH):
(1) If the PSFCH is not received in the PSFCH reception occasion, numConsecutiveDTX may be incremented by 1.

Further, if numConsecutiveDTX reaches sl-maxNumConsecutiveDTX, it may be indicated to the RRC that an RLF has been detected on the HARQ-based sidelink;
(2) otherwise, numConsecutiveDTX may be reinitialized to zero.

Through the foregoing method, the transmitting-end terminal device (Tx UE) may determine, based on a number of consecutive DTX on PSFCH feedback reception occasions, whether an RLF occurs. However, when performing sidelink communication on the unlicensed spectrum, before transmitting the PSFCH, the UE (for example, the receiving-end terminal device (Rx UE)) is required to perform LBT first to determine whether there is an available resource (that is, LBT succeeds), which causes the Tx UE to be unable to determine whether the PSFCH DTX is due to a link problem or due to an LBT failure of the Rx UE, resulting in improper RLF determination.

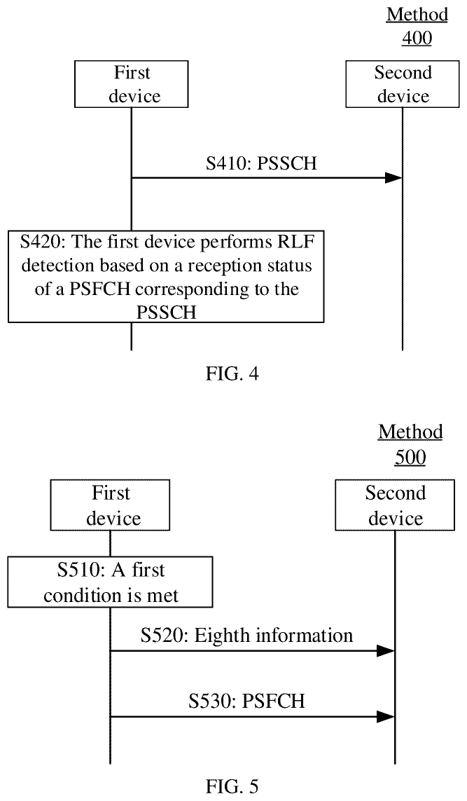

To resolve one or more of the foregoing technical problems, this application provides a communication method and a communications apparatus. The following describes the embodiments of this application in detail with reference to FIG. 4 to FIG. 6.

FIG. 4 is a schematic flowchart of a communication method according to an embodiment of this application. The method 400 shown in FIG. 4 may include steps S410 and S420. Details are as follows.

S410: A first device transmits a PSSCH to a second device.

The first device may be a transmitting-end terminal device (Tx UE), that is, a UE that transmits a PSSCH and/or receives a PSFCH. The second device may be a receiving-end terminal device (Rx UE), that is, a UE that receives a PSSCH and/or transmits a PSFCH.

S420: The first device performs RLF detection based on a reception status of a PSFCH corresponding to the PSSCH.

The PSFCH may be a PSFCH to be fed back by the second device after the PSSCH is received by the second device.

The PSFCH may be transmitted in a licensed band, or may be transmitted in an unlicensed band. For example, after receiving the PSSCH, the second device may transmit the PSFCH to the first device in a licensed band, or may transmit the PSFCH to the first device in an unlicensed band. Before transmitting the PSFCH in the unlicensed band, it is required for the second device to perform LBT.

The reception status of the PSFCH may include the first device receiving the PSFCH in a licensed band or an unlicensed band, or whether the PSFCH being received by the first device; or may include a reason why the first device fails to receive the PSFCH, for example, because the second device fails to transmit the PSFCH due to an LBT failure when transmitting the PSFCH in the unlicensed band; or may include other information or content related to transmission of the PSFCH.

In embodiments of this application, the first device performs RLF detection based on the reception status of the PSFCH corresponding to the PSSCH, thereby facilitating improving accuracy of RLF detection. Accuracy of RLF detection can be improved in the following manners 1 to 4.

Manner 1: A threshold configuration scheme in an RLF determining method based on HARQ feedback is enhanced.

The first device may perform RLF detection based on the reception status of the PSFCH and first information. The first information may be used to configure an unlicensed band, and the first information includes one or more maximum numbers of consecutive DTX on PSFCH reception occasions, or an offset value of one or more maximum numbers of consecutive DTX on PSFCH reception occasions relative to a licensed band. In at least one embodiment, the maximum number of consecutive DTX on PSFCH reception occasions or the offset value of the maximum number of consecutive DTX on PSFCH reception occasions relative to the licensed band in the first information may be in the form of a list.

For example, one or more sl-maxNumConsecutiveDTX-sl_u values or one or more offset values may be configured for the unlicensed band alone, where sl-maxNumConsecutiveDTX-sl_u represents a maximum number of consecutive DTX on PSFCH reception occasions for the unlicensed band, offset represents an offset value relative to sl-maxNumConsecutiveDTX, and sl-maxNumConsecutiveDTX represents a maximum number of consecutive DTX on PSFCH reception occasions corresponding to the licensed band.

In a conventional technology, a network uniformly configures one or more sl-maxNumConsecutiveDTX (without distinguishing between a licensed band or an unlicensed band) values for a sidelink, to indicate a maximum number of consecutive DTX on PSFCH reception occasions corresponding to the licensed band. In embodiments of this application, the offset value relative to sl-maxNumConsecutiveDTX may be added to or subtracted from sl-maxNumConsecutiveDTX, to obtain sl-maxNumConsecutiveDTX-sl_u corresponding to the unlicensed band. For example, if the first information includes offset, sl-maxNumConsecutiveDTX-sl_u=sl-maxNumConsecutiveDTX+offset.

The first information may be related to at least one of the following: a measured value of a CBR in a resource pool corresponding to the first device, an LBT result for the unlicensed band, or a priority of data to be transmitted. In at least one embodiment, the LBT result may include at least one of the following: a quantity of consecutive LBT failures, a quantity of LBT failures within a preset time window, or an energy detection value within a preset time window. In at least one embodiment, the priority of the data to be transmitted may include at least one of the following: a CAPC value and/or a priority value of the PSSCH, a CAPC value and/or a priority value of a PSCCH, or a CAPC value and/or a priority value of a PSFCH to be fed back.

In at least one embodiment, the first information may be specified in a protocol, configured by a network, configured by the first device, or configured by the second device.

The first device may perform RLF detection based on the reception status of the PSFCH and a first value. In at least one embodiment, the first value may be determined by the first device, the second device, or a network device. For example, the first value may be the maximum number of consecutive DTX on PSFCH reception occasions corresponding to the unlicensed band that is determined in the first information, or the offset value of the maximum number of consecutive DTX on PSFCH reception occasions relative to the licensed band that is determined in the first information.

In at least one embodiment, the first value may include one or more values. For example, the first value may include at least one of the following: a value for each link, a value for each resource pool, a value for an RB set, or a value for all sidelink unlicensed bands.

In some embodiments, the first information may be specified in a protocol.

In at least one embodiment, the first value may be determined by the first device based on the first information. For example, in a case in which the first information includes one value, the first device may determine the value as the first value. In a case in which the first information includes a plurality of values, the first device may determine the first value based on a status of the first device. For example, the first device may determine the first value from the first information based on at least one of the following: a measured value of a CBR in a resource pool corresponding to the first device, an LBT result for the unlicensed band, or a priority of data to be transmitted.

Further, the first device may transmit fifth information to the second device, where the fifth information may be used to indicate the first value.

In at least one embodiment, the first value may be determined by the second device based on the first information. For example, in a case in which the first information includes one value, the second device may determine the value as the first value. In a case in which the first information includes a plurality of values, the second device may determine the first value based on a status of the second device. For example, the second device may determine the first value from the first information based on at least one of the following: a measured value of a CBR in a resource pool corresponding to the second device, an LBT result for the unlicensed band, or a priority of data to be transmitted.

Further, the second device may transmit sixth information to the first device, where the sixth information may be used to indicate the first value.

The first device may perform RLF detection based on the reception status of the PSFCH and the first value.

In some embodiments, the first information may be configured by a network. For example, the network device may transmit the first information to the first device and/or the second device.

In at least one embodiment, the first value may be determined by the first device based on the first information. For example, in a case in which the first information includes one value, the first device may determine the value as the first value. In a case in which the first information includes a plurality of values, the first device may determine the first value based on a status of the first device. Further, the first device may transmit fifth information to the second device, where the fifth information may be used to indicate the first value.

In at least one embodiment, the first value may be determined by the second device based on the first information. For example, in a case in which the first information includes one value, the second device may determine the value as the first value. In a case in which the first information includes a plurality of values, the second device may determine the first value based on a status of the second device. Further, the second device may transmit sixth information to the first device, where the sixth information may be used to indicate the first value.

In at least one embodiment, the first information may alternatively be determined by the network device based on a status (a measurement result) of the first device or the second device. Further, the network device may transmit the first information to the first device or the second device. It should be understood that, in this case, the first information may include only one or more maximum numbers of consecutive DTX on PSFCH reception occasions used to configure an unlicensed band, or an offset value of one or more maximum numbers of consecutive DTX on PSFCH reception occasions relative to a licensed band. After receiving the first information, the first device or the second device directly configures the maximum number of consecutive DTX on PSFCH reception occasions for the unlicensed band based on the first information, without determining the first value from the first information.

For example, the first device may transmit fourth information to the network device, where the fourth information may include at least one of the following: a measured value of a CBR in a resource pool corresponding to the first device, an LBT result for the unlicensed band, or a priority of data to be transmitted. In at least one embodiment, the network device may determine the first information based on the fourth information (in this case, the first information may be considered as the first value, that is, the first information includes only the first value). Further, the network device may transmit the first information to the first device. Further, the first device may transmit fifth information to the second device, where the fifth information may be used to indicate the first information.

For another example, the second device may transmit eleventh information to the network device, where the eleventh information may include at least one of the following: a measured value of a CBR in a resource pool corresponding to the second device, an LBT result for the unlicensed band, or a priority of data to be transmitted. In at least one embodiment, the network device may determine the first information based on the eleventh information (in this case, the first information may be considered as the first value, that is, the first information includes only the first value). Further, the network device may transmit the first information to the second device. Further, the second device may transmit sixth information to the first device, where the sixth information may be used to indicate the first information.

In some embodiments, the first information may be configured by the first device. For example, the first device may transmit the first information to the second device.

In at least one embodiment, the first value may be determined by the first device based on the first information. For example, in a case in which the first information includes one value, the first device may determine the value as the first value. In a case in which the first information includes a plurality of values, the first device may determine the first value based on a status of the first device. Further, the first device may transmit fifth information to the second device, where the fifth information may be used to indicate the first value.

For another example, in a case in which the first information includes a plurality of values, the first device may alternatively determine the first value based on a status (a measurement result) of the other party (the second device). For example, the first device may determine the first value from the first information based on at least one of the following: a measured value of a CBR in a resource pool corresponding to the second device, an LBT result for the unlicensed band, or a priority of data to be transmitted. In at least one embodiment, the second device may transmit a measurement result of the second device to the first device. The measurement result may be triggered periodically, based on a predetermined condition, or based on a request from the first device. For example, the predetermined condition include that an initial connection is established, a state changes, or a preset event occurs (for example, being higher than a specific threshold, being lower than a specific threshold, or a change amount exceeds a specific threshold within a specific period of time). The request from the first device may be transmitted by using physical layer signalling, MAC layer signalling, or RRC layer signalling.

Further, the first device may transmit fifth information to the second device, where the fifth information may be used to indicate the first value.

In at least one embodiment, the first value may be determined by the second device based on the first information. For example, in a case in which the first information includes one value, the second device may determine the value as the first value. In a case in which the first information includes a plurality of values, the second device may determine the first value based on a status of the second device. Further, the second device may transmit sixth information to the first device, where the sixth information may be used to indicate the first value.

Alternatively, the first device may negotiate with the second device to determine the first value.

For example, the second device may transmit third information to the first device, where the third information may be used to indicate one or more values. Further, the first device may determine the first value from the first information based on the third information. Further, the first device may transmit fifth information to the second device, where the fifth information may be used to indicate the first value.

For another example, the first device may transmit seventh information to the second device, where the seventh information may be used to indicate one or more values. Further, the second device may determine the first value from the first information based on the seventh information. Further, the second device may transmit sixth information to the first device, where the sixth information may be used to indicate the first value.

In some embodiments, the first information may be configured by the second device. For example, the second device may transmit the first information to the first device.

In at least one embodiment, the first value may be determined by the first device or the second device based on the first information. For example, in a case in which the first information includes one value, the first device may determine the value as the first value. In a case in which the first information includes a plurality of values, the first device may determine the first value based on a status of the first device. Further, the first device may transmit fifth information to the second device, where the fifth information may be used to indicate the first value.

In at least one embodiment, the first value may be determined by the first device or the second device based on the first information. For example, in a case in which the first information includes one value, the second device may determine the value as the first value. In a case in which the first information includes a plurality of values, the second device may determine the first value based on a status of the second device. Further, the second device may transmit sixth information to the first device, where the sixth information may be used to indicate the first value.

Alternatively, the first device may negotiate with the second device to determine the first value.

For example, the second device may transmit third information to the first device, where the third information may be used to indicate one or more values. Further, the first device may determine the first value from the first information based on the third information. Further, the first device may transmit fifth information to the second device, where the fifth information may be used to indicate the first value.

For another example, the first device may transmit seventh information to the second device, where the seventh information may be used to indicate one or more values. Further, the second device may determine the first value from the first information based on the seventh information. Further, the second device may transmit sixth information to the first device, where the sixth information may be used to indicate the first value.

In at least one embodiment, after determining the first value, the first device or the second device may report the first value to the network device. For example, the first device may transmit twelfth information to the network device, where the twelfth information may be used to indicate the first value.

In embodiments of this application, the maximum number of consecutive DTX on PSFCH reception occasions (that is, sl-maxNumConsecutiveDTX-sl_u) corresponding to the unlicensed band is determined based on the first value, so that RLF detection can be performed in different manners for the licensed band and the unlicensed band, thereby being conducive to improving accuracy of RLF detection.

Manner 2: A counter in an RLF determining method based on HARQ feedback is enhanced.

The first device may count a number of consecutive DTX on PSFCH reception occasions by using a first counter. Further, the first device may perform RLF detection based on the first counter. In at least one embodiment, the first counter may be numConsecutiveDTX.

In at least one embodiment, a counting method of the first counter may be enhanced.

In at least one embodiment, the first device may perform counting for a specific PSFCH by using the first counter. The specific PSFCH may include at least one of the following: a PSFCH not received within COT shared by the first device with the second device; or one of a plurality of PSFCH transmission occasions corresponding to a same PSSCH.

For example, in PSFCHs not received, the first device may perform counting, by using the first counter, only for a PSFCH transmitted within COT that is shared with the second device. For another example, in a plurality of PSFCH transmission occasions corresponding to a same PSSCH, the first device may perform counting, by using the first counter, only for a PSFCH transmitted in a first PSFCH transmission occasion (in the plurality of PSFCH transmission occasions), or may perform counting only for a PSFCH transmitted in a last PSFCH transmission occasion, or may perform counting only for a PSFCH transmitted in any other PSFCH transmission occasion.

In at least one embodiment, the first counter may be set to 0 when a trigger condition is met. For example, the first device may set the first counter to 0 when at least one of the following conditions is met:
the first device triggers resource reselection or resource pool reselection; a configured grant (CG) resource or a resource pool for the first device is re-configured; the first device receives an LBT failure indication from the second device; or the first device fails to perform an LBT. In at least one embodiment, the LBT failure of the first device may include an LBT failure of the first device for the PSSCH and/or an LBT failure of the first device for the PSFCH.

In at least one embodiment, N may be subtracted from the first counter when the trigger condition is met, where N is a positive integer. For example, the first device may subtract N from the first counter when at least one of the following conditions is met: the first device triggers resource reselection or resource pool reselection; a CG resource or a resource pool for the first device is re-configured; the first device receives an LBT failure indication from the second device; or the first device fails to perform an LBT.

In at least one embodiment, at least one of the resource reselection or the CG resource re-configuration may be triggered by an LBT failure. In at least one embodiment, the LBT failure (for example, the LBT failure of the first device) may include an LBT failure of the first device for the PSSCH and/or an LBT failure of the first device for the PSFCH.

In embodiments of this application, a counting method of the first counter is enhanced by using the foregoing plurality of manners, so that the RLF detection can be accurately performed for different cases, thereby being conducive to improving accuracy of RLF detection.

Manner 3: A transmitting-end UE (such as the first device) is enhanced. The method in Manner 3 is described in detail below with reference to FIG. 5.

S520: The first device transmits eighth information to the second device when a first condition is met.

In at least one embodiment, the eighth information may be used to indicate shared COT of the first device. For example, the eighth information may be used to indicate at least one of the following: a PSFCH resource location, a PSFCH resource within the shared COT, or a PSFCH transmission occasion within the shared COT. In at least one embodiment, the eighth information may be used to instruct or trigger the second device to transmit a PSFCH based on the shared COT. The eighth information may be transmitted together with new data or data to be retransmitted, or may be transmitted alone.

In at least one embodiment, the eighth information may be transmitted by using physical layer signalling (such as sidelink control information (sidelink control information, SCI)), MAC layer signalling, or RRC layer signalling (which may be transmitted alone).

In at least one embodiment, before step S520, step S510 may be performed. Details are as follows.

S510: it is determined whether a first condition is met.

In at least one embodiment, the first condition may include at least one of the following:
the first device is to transmit feedback enabled (feedback enable) new data or retransmission data to the second device; the first device fails to receive, for consecutive M times, a PSFCH feedback transmitted by the second device; the first device initializes (or initialized) available shared COT after LBT is successful (for example, Type-1 LBT is successful); there is a PSFCH resource or a PSFCH transmission occasion in available shared COT; a request from the second device is received; triggered by a preset event; or triggered by a network, where M is a positive integer.

In at least one embodiment, the preset event may include at least one of the following:
a measured value of a CBR in a resource pool corresponding to the first device is greater than or equal to a first threshold; a quantity of consecutive LBT failures is greater than a second threshold; a quantity of LBT failures within a preset time window is greater than a third threshold; an energy detection value within a preset time window is greater than a fourth threshold; or a priority of data to be transmitted reaches a fifth threshold. In at least one embodiment, the data to be transmitted may be a PSSCH, a PSCCH, or a PSFCH to be fed back. In at least one embodiment, the priority of the data to be transmitted reaching the fifth threshold may include that at least one of a CAPC value or a priority value of the PSSCH, the PSCCH, or the PSFCH to be fed back is greater than or equal to the fifth threshold, or may include that at least one of a CAPC value or a priority value of the PSSCH, the PSCCH, or the PSFCH to be fed back is less than or equal to the fifth threshold.

In at least one embodiment, the threshold or the threshold value in the foregoing embodiment may be configured by a network, determined by the first device, or determined by the second device.

In at least one embodiment, after step S520, step S530 may be performed. Details are as follows.

S530: The second device transmits the PSFCH to the first device within the shared COT (for example, the shared COT of the first device).

In embodiments of this application, the first device transmits the eighth information to the second device when the first condition is met, such that the second device can transmit the PSFCH within the shared COT, thereby reducing a probability that the second device fails to transmit the PSFCH, thus being conducive to improving accuracy of RLF detection.

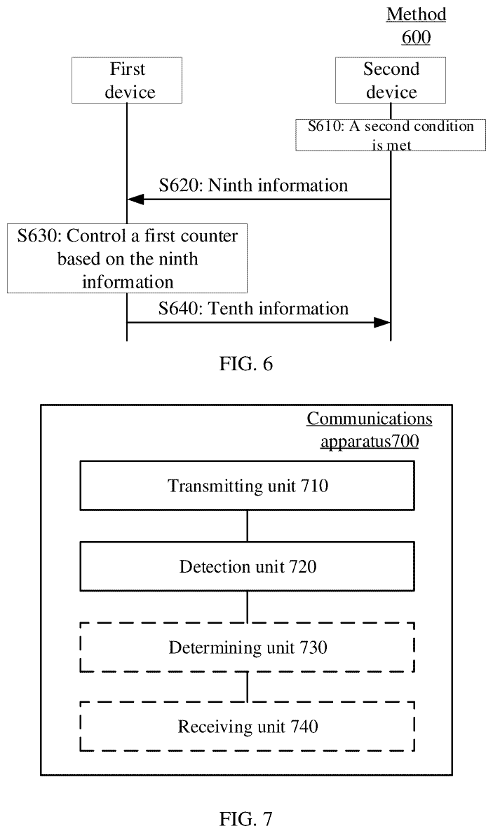

Manner 4: A receiving-end UE (such as the second device) is enhanced. The method in Manner 4 is described in detail below with reference to FIG. 6.

S620: The second device transmits ninth information to the first device when a second condition is met.

In at least one embodiment, the ninth information may be used to indicate that the second device fails to perform an LBT. For example, the ninth information may be 1-bit indication information. The ninth information may further include K feedbacks, failing to be transmitted by the second device, for the PSSCH from the first device. In at least one embodiment, the ninth information may be transmitted by using physical layer signalling, MAC layer signalling, or RRC layer signalling. In at least one embodiment, the ninth information may be used to trigger the first device to transmit the shared COT to the second device.

In at least one embodiment, in a case that the ninth information includes K feedbacks, failing to be transmitted by the second device, for the PSSCH from the first device, the first device may determine, based on the K feedbacks for the PSSCH from the first device, whether to transmit new data or retransmit data to the second device.

In at least one embodiment, before step S620, step S610 may be performed. Details are as follows.

S610: it is determined whether a second condition is met.

In at least one embodiment, the second condition may include at least one of the following:
K feedbacks for the PSSCH from the first device fail to transmitted due to an LBT failure; or LBT is successful and there is an available resource for the PSSCH, a PSCCH, a PSBCH, and/or a synchronization signal block SSB, where K is a positive integer.

In at least one embodiment, after step S620, step S630 may be performed. Details are as follows.

S630: The first device controls the first counter based on the ninth information.

In at least one embodiment, the first counter may be configured to count a number of consecutive DTX on PSFCH reception occasions. For example, for the K feedbacks, included in the ninth information, for the PSSCH from the first device, the first device may not increment a value of the first counter (if a value has been incremented, the value may be decremented); or the first device may set the first counter to 0.

In at least one embodiment, after step S620, step S640 may be performed. Details are as follows.

S640: The first device transmits tenth information to the second device.

In at least one embodiment, the tenth information may be used to indicate shared COT of the first device. In at least one embodiment, the tenth information may be transmitted by using physical layer signalling, MAC layer signalling, or RRC layer signalling.

In embodiments of this application, the second device transmits the ninth information to the first device when the second condition is met, to trigger the first device to transmit the shared COT to the second device, such that the second device can transmit the PSFCH within the shared COT, thereby reducing a probability that the second device fail to transmit the PSFCH, thus being conducive to improving accuracy of RLF detection.

The method embodiments of this application are described above in detail with reference to FIG. 1 to FIG. 6. Apparatus embodiments of this application are described below in detail with reference to FIG. 7 to FIG. 9. It should be understood that the descriptions of the method embodiments correspond to descriptions of the apparatus embodiments, and therefore, for parts that are not described in detail, reference may be made to the foregoing method embodiments.

FIG. 7 is a schematic structural diagram of a communications apparatus according to an embodiment of this application. As shown in FIG. 7, the apparatus 700 includes a transmitting unit 710 and a detection unit 720. Details are as follows.

The transmitting unit 710 is configured to transmit a physical sidelink shared channel PSSCH to a second device.

The detection unit 720 is configured to perform radio link failure RLF detection based on a reception status of a physical sidelink feedback channel PSFCH corresponding to the PSSCH.

In at least one embodiment, the detection unit 720 is specifically configured to: perform RLF detection based on the reception status of the PSFCH and first information, where the first information is used to configure an unlicensed band, and the first information includes one or more maximum numbers of consecutive DTX on PSFCH reception occasions, or an offset value of one or more maximum numbers of consecutive DTX on PSFCH reception occasions relative to a licensed band.

In at least one embodiment, the first information is related to at least one of the following: a measured value of a channel busy ratio CBR in a resource pool corresponding to the apparatus, a listen before talk LBT result for the unlicensed band, or a priority of data to be transmitted.

In at least one embodiment, the first information is specified in a protocol, configured by a network, configured by the apparatus, or configured by the second device.

In at least one embodiment, the detection unit 720 is further specifically configured to determine a first value based on the first information; and perform RLF detection based on the reception status of the PSFCH and the first value.

In at least one embodiment, the determining unit 730 is specifically configured to determine the first value from the first information based on at least one of the following: a measured value of a channel busy ratio CBR in a resource pool corresponding to the apparatus, a listen before talk LBT result for the unlicensed band, or a priority of data to be transmitted.

In at least one embodiment, the determining unit 730 is specifically configured to determine the first value from the first information based on at least one of the following: a measured value of a channel busy ratio CBR in a resource pool corresponding to the second device, a listen before talk LBT result for the unlicensed band, or a priority of data to be transmitted.

In at least one embodiment, the apparatus 700 further includes a receiving unit 740, configured to receive third information transmitted by the second device, where the third information is used to indicate one or more values, where the determining unit 730 is specifically configured to determine the first value from the first information based on the third information.

In at least one embodiment, the receiving unit 740 is further configured to receive the first information transmitted by the network device.

In at least one embodiment, before the receiving the first information transmitted by the network device, the transmitting unit 710 is further configured to transmit fourth information to the network device, where the fourth information includes at least one of the following: a measured value of a channel busy ratio CBR in a resource pool corresponding to the apparatus, a listen before talk LBT result for the unlicensed band, or a priority of data to be transmitted.

In at least one embodiment, the LBT result for the unlicensed band includes at least one of the following: a quantity of consecutive LBT failures, a quantity of LBT failures within a preset time window, or an energy detection value within a preset time window; and the priority of the data to be transmitted includes at least one of the following: a channel access priority class CAPC value and/or a priority value of the PSSCH, a CAPC value and/or a priority value of a PSCCH, or a CAPC value and/or a priority value of a PSFCH to be fed back.

In at least one embodiment, the transmitting unit 710 is further configured to transmit fifth information to the second device, where the fifth information is used to indicate the first information or the first value in the first information.

In at least one embodiment, the receiving unit 740 is further configured to receive sixth information transmitted by the second device, where the sixth information is used to indicate the first information or the first value in the first information.

In at least one embodiment, before the receiving the sixth information transmitted by the second device, the transmitting unit 710 is further configured to transmit seventh information to the second device, where the seventh information is used to indicate one or more values.

In at least one embodiment, the transmitting unit 710 is further configured to transmit twelfth information to a network device, where the twelfth information is used to indicate the first value.

In at least one embodiment, the first value includes at least one of the following: a value for each link, a value for each resource pool, a value for a resource block RB set, or a value for all sidelink unlicensed bands.

In at least one embodiment, the detection unit 720 is specifically configured to: count a number of consecutive DTX on PSFCH reception occasions by using a first counter; and perform RLF detection based on the first counter.

In at least one embodiment, the detection unit 720 is specifically configured to perform counting for a specific PSFCH by using the first counter.

In at least one embodiment, the specific PSFCH includes at least one of the following: a PSFCH not received within shared channel occupancy time COT shared by the apparatus with the second device; or one of a plurality of PSFCH transmission occasions corresponding to a same PSSCH.

In at least one embodiment, the detection unit 720 is specifically configured to set the first counter to 0 when at least one of the following conditions is met: the apparatus triggers resource reselection or resource pool reselection; a configured grant CG resource or a resource pool for the apparatus is re-configured; the apparatus receives an LBT failure indication from the second device; or the apparatus fails to perform an LBT.

In at least one embodiment, the detection unit 720 is specifically configured to subtract N from the first counter when at least one of the following conditions is met: the apparatus triggers resource reselection or resource pool reselection; a configured grant CG resource or a resource pool for the apparatus is re-configured; the apparatus receives an LBT failure indication from the second device; or the apparatus fails to perform an LBT, where N is a positive integer.

In at least one embodiment, at least one of the resource reselection or the CG resource re-configuration is triggered by an LBT failure.

In at least one embodiment, the LBT failure of the apparatus includes: an LBT failure of the apparatus for the PSSCH or an LBT failure of the apparatus for the PSFCH.

In at least one embodiment, the transmitting unit 710 is further configured to transmit eighth information to the second device when a first condition is met, where the eighth information is used to indicate shared channel occupancy time COT of the apparatus.

In at least one embodiment, the first condition includes at least one of the following: the apparatus is to transmit feedback enabled new data or retransmission data to the second device; the apparatus fails to receive, for consecutive M times, a PSFCH feedback transmitted by the second device; the apparatus initializes available shared COT after LBT is successful; there is a PSFCH resource or a PSFCH transmission occasion in available shared COT; a request from the second device is received; triggered by a preset event; or triggered by a network, where M is a positive integer.

In at least one embodiment, the preset event includes at least one of the following: a measured value of a channel busy ratio CBR in a resource pool corresponding to the apparatus is greater than or equal to a first threshold; a quantity of consecutive LBT failures is greater than a second threshold; a quantity of LBT failures within a preset time window is greater than a third threshold; an energy detection value within a preset time window is greater than a fourth threshold; or a priority of data to be transmitted reaches a fifth threshold.

In at least one embodiment, the eighth information is used to indicate at least one of the following: a PSFCH resource location, a PSFCH resource within the shared COT, or a PSFCH transmission occasion within the shared COT.

In at least one embodiment, the eighth information is transmitted by using physical layer signalling, medium access control MAC layer signalling, or radio resource control RRC layer signalling.

In at least one embodiment, the apparatus 700 further includes a receiving unit 740, configured to receive ninth information transmitted by the second device when a second condition is met, where the ninth information is used to indicate that the second device fails to perform an LBT.

In at least one embodiment, the second condition includes at least one of the following: K feedbacks for the PSSCH from the apparatus fail to be transmitted due to an LBT failure; or LBT is successful and there is an available resource for the PSSCH, a physical sidelink control channel PSCCH, a physical sidelink broadcast channel PSBCH, and/or a synchronization signal block SSB, where K is a positive integer.

In at least one embodiment, the ninth information further includes K feedbacks, failing to be transmitted by the second device, for the PSSCH from the apparatus.

In at least one embodiment, the ninth information is transmitted by using physical layer signalling, medium access control MAC layer signalling, or radio resource control RRC layer signalling.

In at least one embodiment, the transmitting unit 710 is further configured to transmit tenth information to the second device, where the tenth information is used to indicate shared channel occupancy time COT of the apparatus.

In at least one embodiment, the tenth information is transmitted by using physical layer signalling, medium access control MAC layer signalling, or radio resource control RRC layer signalling.

In at least one embodiment, the detection unit 720 is further configured to control a first counter based on the ninth information, where the first counter is configured to count a number of consecutive DTX on PSFCH reception occasions.

In at least one embodiment, the detection unit 720 is specifically configured to skip incrementing a value of the first counter for K feedbacks, included in the ninth information, for the PSSCH from the apparatus; or set the first counter to 0.

In at least one embodiment, the apparatus 700 further includes a determining unit 730, configured to: in a case that the ninth information includes K feedbacks, failing to be transmitted by the second device, for the PSSCH from the apparatus, determine, based on the K feedbacks for the PSSCH from the apparatus, whether to transmit new data or retransmit data to the second device.

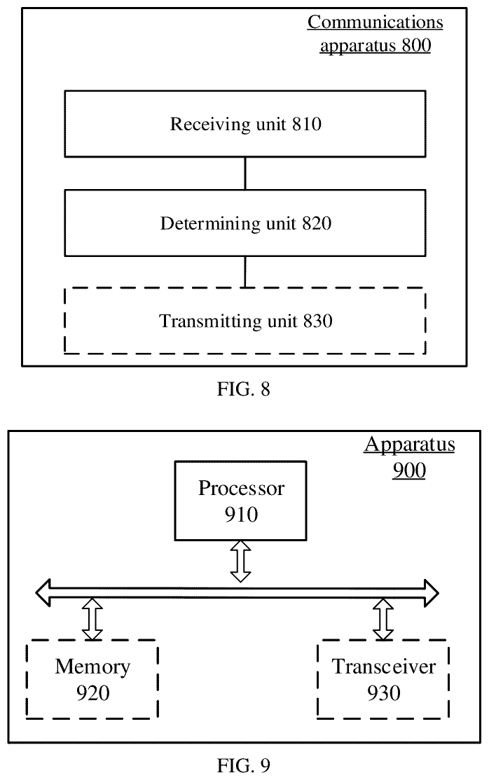

FIG. 8 is a schematic structural diagram of a communications apparatus according to an embodiment of this application. The communications apparatus 800 in FIG. 8 includes a receiving unit 810 and a determining unit 820. Details are as follows.

The receiving unit 810 is configured to receive a physical sidelink shared channel PSSCH transmitted by a first device.

The determining unit 820 is configured to determine whether to transmit a physical sidelink feedback channel PSFCH corresponding to the PSSCH.

In at least one embodiment, the receiving unit 810 is further configured to receive first information transmitted by the first device, where the first information is used to configure an unlicensed band, and the first information includes one or more maximum numbers of consecutive DTX on PSFCH reception occasions, or an offset value of one or more maximum numbers of consecutive DTX on PSFCH reception occasions relative to a licensed band. The apparatus 800 further includes a transmitting unit 830, configured to transmit third information to the first device, where the third information is used to indicate one or more values.

In at least one embodiment, the receiving unit 810 is further configured to receive fifth information transmitted by the first device, where the fifth information is used to indicate the first information or the first value in the first information.

In at least one embodiment, the receiving unit 810 is further configured to receive first information transmitted by a network device, where the first information is used to configure an unlicensed band, and the first information includes one or more maximum numbers of consecutive DTX on PSFCH reception occasions, or an offset value of one or more maximum numbers of consecutive DTX on PSFCH reception occasions relative to a licensed band.

In at least one embodiment, the apparatus 800 further includes a transmitting unit 830, and before receiving the first information transmitted by the network device, the transmitting unit 830 is configured to transmit eleventh information to the network device. The eleventh information includes at least one of the following: a measured value of a channel busy ratio CBR in a resource pool corresponding to the apparatus, a listen before talk LBT result for the unlicensed band, or a priority of data to be transmitted.

In at least one embodiment, the LBT result for the unlicensed band includes at least one of the following: a quantity of consecutive LBT failures, a quantity of LBT failures within a preset time window, or an energy detection value within a preset time window; and the priority of the data to be transmitted includes at least one of the following: a channel access priority class CAPC value and/or a priority value of the PSSCH, a CAPC value and/or a priority value of a PSCCH, or a CAPC value and/or a priority value of a PSFCH to be fed back.

In at least one embodiment, the determining unit 820 is further configured to determine the first value based on the first information.

In at least one embodiment, the determining unit 820 is specifically configured to determine the first value from the first information based on at least one of the following: a measured value of a channel busy ratio CBR in a resource pool corresponding to the apparatus, a listen before talk LBT result for the unlicensed band, or a priority of data to be transmitted.

In at least one embodiment, the determining unit 820 is specifically configured to determine the first value from the first information based on at least one of the following: a measured value of a channel busy ratio CBR in a resource pool corresponding to the first device, a listen before talk LBT result for the unlicensed band, or a priority of data to be transmitted.

In at least one embodiment, the receiving unit 810 is further configured to receive seventh information transmitted by the first device, where the seventh information is used to indicate one or more values. The determining unit 820 is specifically configured to determine the first value from the first information based on the seventh information.

In at least one embodiment, the apparatus 800 further includes a transmitting unit 830, configured to transmit sixth information to the first device, where the sixth information is used to indicate the first information or a first value in the first information.

In at least one embodiment, the apparatus 800 further includes a transmitting unit 830, configured to transmit twelfth information to a network device, where the twelfth information is used to indicate the first value.

In at least one embodiment, the first value includes at least one of the following: a value for each link, a value for each resource pool, a value for a resource block RB set, or a value for all sidelink unlicensed bands.

In at least one embodiment, the receiving unit 810 is further configured to receive eighth information transmitted by the first device when a first condition is met, where the eighth information is used to indicate shared channel occupancy time COT of the first device.

In at least one embodiment, the first condition includes at least one of the following: the first device is to transmit feedback enabled new data or retransmission data to the apparatus; the first device fails to receive, for consecutive M times, a PSFCH feedback transmitted by the apparatus; the first device initializes available shared COT after LBT is successful; there is a PSFCH resource or a PSFCH transmission occasion in available shared COT; a request from the apparatus is received; triggered by a preset event; or triggered by a network, where M is a positive integer.

In at least one embodiment, the preset event includes at least one of the following: a measured value of a channel busy ratio CBR in a resource pool corresponding to the first device is greater than or equal to a first threshold; a quantity of consecutive LBT failures is greater than a second threshold; a quantity of LBT failures within a preset time window is greater than a third threshold; an energy detection value within a preset time window is greater than a fourth threshold; or a priority of data to be transmitted reaches a fifth threshold.

In at least one embodiment, the eighth information is used to indicate at least one of the following: a PSFCH resource location, a PSFCH resource within the shared COT, or a PSFCH transmission occasion within the shared COT.

In at least one embodiment, the eighth information is transmitted by using physical layer signalling, medium access control MAC layer signalling, or radio resource control RRC layer signalling.

In at least one embodiment, the apparatus 800 further includes a transmitting unit 830, configured to transmit ninth information to the first device when a second condition is met, where the ninth information is used to indicate that the apparatus fails to perform an LBT.

In at least one embodiment, the second condition includes at least one of the following: K feedbacks for the PSSCH from the first device fail to be transmitted due to an LBT failure; or LBT is successful and there is an available resource for the PSSCH, a physical sidelink control channel PSCCH, a physical sidelink broadcast channel PSBCH, and/or a synchronization signal block SSB, where K is a positive integer.

In at least one embodiment, the ninth information further includes K feedbacks, failing to be transmitted by the apparatus, for the PSSCH from the first device.

In at least one embodiment, the ninth information is transmitted by using physical layer signalling, medium access control MAC layer signalling, or radio resource control RRC layer signalling.

In at least one embodiment, the receiving unit 810 is further configured to receive tenth information transmitted by the first device, where the tenth information is used to indicate shared channel occupancy time COT of the first device.

In at least one embodiment, the tenth information is transmitted by using physical layer signalling, medium access control MAC layer signalling, or radio resource control RRC layer signalling.

FIG. 9 is a schematic structural diagram of an apparatus according to an embodiment of this application. Dashed lines in FIG. 9 indicate that the unit or module is optional. The apparatus 900 may be configured to implement the method described in the foregoing method embodiments. The apparatus 900 may be a chip or a communications apparatus.

The apparatus 900 may include one or more processors 910. The processor 910 may support the apparatus 900 in implementing the methods described in the foregoing method embodiments. The processor 910 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 620 stores a program that may be executed by the processor 910 to cause the processor 910 to perform the methods described in the foregoing method embodiments. The memory 920 may be separate from the processor 910 or may be integrated into the processor 910.

The apparatus 900 may further include a transceiver 930. The processor 910 may communicate with another device or chip through the transceiver 930. For example, the processor 910 may transmit data to and receive data from another device or chip through the transceiver 930.

An embodiment of this application further provides a computer-readable storage medium, configured to store a program. The computer-readable storage medium may be applied to the communications apparatus provided in embodiments of this application, and the program causes a computer to perform the method executed by the communications apparatus in various embodiments of this application.

An embodiment of this application further provides a computer program product. The computer program product includes a program. The computer program product may be applied to the communications apparatus provided in embodiments of this application, and the program causes a computer to perform the method executed by the communications apparatus in various embodiments of this application.

An embodiment of this application further provides a computer program. The computer program may be applied to the communications apparatus provided in embodiments of this application, and the computer program causes a computer to perform the method executed by the communications apparatus in various embodiments of this application.

It should be understood that, in embodiments of this application, “B that is corresponding to A” means that B is associated with A, and B may be determined based on A. However, it should be further understood that determining B according to A does not mean determining B according to A only, and may further determine B according to A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of the embodiments of this application.

In the several embodiments provided in this application, it should be understood that the disclosed system, apparatus, and method may be implemented in another manner. For example, the apparatus embodiments described above are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interface, apparatuses or units, and may be implemented in electrical, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
transmitting, by a first device, a physical sidelink shared channel PSSCH to a second device; and
performing, by the first device, radio link failure RLF detection based on a reception status of a physical sidelink feedback channel PSFCH corresponding to the PSSCH.

2. The method according to claim 1, wherein the performing, by the first device, RLF detection based on the reception status of the PSFCH corresponding to the PSSCH comprises:
performing, by the first device, RLF detection based on the reception status of the PSFCH and first information, wherein the first information is used to configure an unlicensed band, and the first information comprises one or more maximum numbers of consecutive DTX (discontinuities reception) on PSFCH reception occasions, or an offset value of one or more maximum numbers of consecutive DTX on PSFCH reception occasions relative to a licensed band.

3. The method according to claim 2, wherein the first information is related to at least one of following:
a measured value of a channel busy ratio CBR in a resource pool corresponding to the first device, a listen before talk LBT result for the unlicensed band, or a priority of data to be transmitted.

4. The method according to claim 2, wherein the first information is specified in a protocol, configured by a network, configured by the first device, or configured by the second device.

5. The method according to claim 4, wherein the performing, by the first device, RLF detection based on the reception status of the PSFCH and the first information comprises:
determining, by the first device, a first value based on the first information; and
performing, by the first device, RLF detection based on the reception status of the PSFCH and the first value.

6. The method according to claim 5, wherein the determining, by the first device, the first value based on the first information comprises:
determining, by the first device, the first value from the first information based on at least one of following:
a measured value of a channel busy ratio CBR in a resource pool corresponding to the first device, a listen before talk LBT result for the unlicensed band, or a priority of data to be transmitted;
or wherein the determining, by the first device, the first value based on the first information comprises:
determining, by the first device, the first value from the first information based on at least one of following:
a measured value of a channel busy ratio CBR in a resource pool corresponding to the second device, a listen before talk LBT result for the unlicensed band, or a priority of data to be transmitted.

7. The method according to claim 5, further comprising:
receiving, by the first device, third information transmitted by the second device, wherein the third information is used to indicate one or more values,
wherein the determining, by the first device, the first value based on the first information comprises:
determining, by the first device, the first value from the first information based on the third information.

8. The method according to claim 3, wherein the LBT result for the unlicensed band comprises at least one of following: a quantity of consecutive LBT failures, a quantity of LBT failures within a preset time window, or an energy detection value within a preset time window; and the priority of the data to be transmitted comprises at least one of following: a channel access priority class CAPC value and/or a priority value of the PSSCH, a CAPC value and/or a priority value of a PSCCH, or a CAPC value and/or a priority value of a PSFCH to be fed back.

9. The method according to claim 1, wherein the performing, by the first device, RLF detection based on the reception status of the PSFCH corresponding to the PSSCH comprises:
counting, by the first device by using a first counter, a number of consecutive DTX on PSFCH reception occasions; and
performing, by the first device, RLF detection based on the first counter.

10. The method according to claim 9, wherein the counting, by the first device by using the first counter, a number of consecutive DTX on PSFCH reception occasions comprises:
performing counting, by the first device, for a specific PSFCH by using the first counter.

11. The method according to claim 10, wherein the specific PSFCH comprises at least one of following:
a PSFCH not received within shared channel occupancy time COT shared by the first device with the second device;
one of a plurality of PSFCH transmission occasions corresponding to a same PSSCH; or
a last PSFCH transmission occasion corresponding to the PSSCH.

12. The method according to claim 9, wherein the counting, by the first device by using the first counter, the number of consecutive DTX on PSFCH reception occasions comprises:
setting, by the first device, the first counter to 0 when at least one of following conditions is met: the first device triggers resource reselection or resource pool reselection; a configured grant CG resource or a resource pool for the first device is re-configured; an LBT failure indication from the second device is received by the first device; or the first device fails to perform LBT;
or wherein the counting, by the first device by using the first counter, the number of consecutive DTX on PSFCH reception occasions comprises:
subtracting, by the first device, N from first counter when at least one of following conditions is met: the first device triggers resource reselection or resource pool reselection; a configured grant CG resource or a resource pool for the first device is re-configured; an LBT failure indication from the second device is received by the first device; or the first device fails to perform LBT, wherein N is a positive integer.

13. The method according to claim 12, wherein at least one of the resource reselection or the CG resource re-configuration is triggered by an LBT failure.

14. The method according to claim 12, wherein the LBT failure of the first device comprises:
an LBT failure of the first device for the PSSCH or an LBT failure of the first device for the PSFCH.

15. The method according to claim 1, further comprising:
transmitting, by the first device, eighth information to the second device when a first condition is met, wherein the eighth information is used to indicate shared channel occupancy time COT of the first device;
wherein the first condition comprises at least one of following:
the first device is to transmit feedback enabled new data or retransmission data to the second device; the first device fails to receive, for consecutive M times, a PSFCH feedback transmitted by the second device; the first device initializes available shared COT after LBT is successful;
there is a PSFCH resource or a PSFCH transmission occasion in available shared COT; a request from the second device is received; triggered by a preset event; or triggered by a network, wherein M is a positive integer.

16. A communications apparatus, wherein the communication apparatus is a first device, the first device comprises a memory and a processor, the memory is configured to store a computer program, and the processor is configured to execute the computer program stored in the memory to cause the communication apparatus to perform operations comprising:
transmitting a physical sidelink shared channel PSSCH to a second device; and
performing radio link failure RLF detection based on a reception status of a physical sidelink feedback channel PSFCH corresponding to the PSSCH.

17. The apparatus according to claim 16, wherein the apparatus is specifically configured to count a number of consecutive DTX on PSFCH reception occasions by using a first counter; and perform RLF detection based on the first counter.

18. The apparatus according to claim 17, wherein the apparatus is specifically configured to perform counting for a specific PSFCH by using the first counter.

19. The apparatus according to claim 18, wherein the specific PSFCH comprises at least one of following: a PSFCH not received within shared channel occupancy time COT shared by the apparatus with the second device; one of a plurality of PSFCH transmission occasions corresponding to a same PSSCH; or a last PSFCH transmission occasion corresponding to the PSSCH.

20. A communications apparatus, wherein the communications apparatus is a second device, the second device comprises a memory and a processor, the memory is configured to store a computer program, and the processor is configured to execute the computer program stored in the memory to cause the communication apparatus to perform operations comprising:
receiving a physical sidelink shared channel PSSCH transmitted by a first device; and
determining whether to transmit a physical sidelink feedback channel PSFCH corresponding to the PSSCH.
